(19) United States
(12) Patent Application Publication
(10) Pub. No.: US 2005/0016449 A1
(43) Pub. Date: Jan. 27, 2005

(54) PHOTORESIST COATING SYSTEM

(76) Inventors: Wang-Sheng Chen, Kao-Hsiung City (TW); Tseng-Kuei Tseng, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,395

(22) Filed: Jul. 7, 2004

(30) Foreign Application Priority Data
Jul. 11, 2003 (CN) 03147269.9

(51) Int. Cl. B05C 11/00; G03C 5/00

(52) U.S. Cl. 118/666; 118/668

(57) ABSTRACT

The present invention discloses a photoresist coating system. The photoresist coating system mainly includes a chemical tank for positioning at least one photoresist bottle that is used for storing photoresist solution supplied to the photoresist coating system, a cooling system for chilling the photoresist solution in the photoresist bottle to a low temperature, a heating system for heating the photoresist solution transferred from the photoresist bottle to an adequate temperature, and an automatic photoresist feed system for draining and delivering the photoresist solution.

### BACKGROUND OF INVENTION

1. Field of the Invention

The present invention relates to a photoresist coating system applied in photolithography processes, and more particularly, to a photoresist coating system having a cooling system and a heating system to preserve photoresist solution not used yet at a low temperature to avoid undergoing a chemical change and to heat transferred photoresist solution to a room temperature at any time to supply a production line.

2. Description of the Prior Art

A photolithography process is utilized very extensively. When fabricating devices, such as semiconductor devices, opto-electronics devices, etc., the photolithography process is utilized to transfer electronic components and circuits, in a layer upon layer manner, to a substrate including a wafer or a plastic substrate. Generally speaking, a photolithography process includes three fundamental steps: photoresist coating, exposure, and development. The photoresist solution is in a liquid form because there is solvent in the photoresist solution. Therefore, a high speed spinning method is usually utilized in the photoresist coating process to generate a centrifugal force such that the photoresist solution is evenly coated on the substrate. The photoresist layer formed on the surface of the substrate is thus expected to have a good thickness uniformity, good adhesion, and no defects. In addition, the quality of the formed photoresist layer is not only related to the viscosity of the photoresist solution, but also is related to other factors, such as the spinning speed, the temperature of the photoresist solution, the humidity, and exhaust air rate.

Please refer to FIG. 1 and FIG. 2. FIG. 1 is a structural schematic diagram of a prior art photoresist coating system 10. FIG. 2 is a viscosity of photoresist solution-storage time curve at different temperatures. In order to fulfill the requirements of different processes, two different photoresist solutions are usually positioned in the photoresist coating system 10 that is very frequently used in photolithography processes, as shown in FIG. 1. The two photoresist solutions are thus switchable at any time. Under the circumstances, the prior art photoresist coating system 10 mainly comprise a chemical tank 12 for positioning two photoresist bottles 13, 14 and a dispense pump 20. The photoresist bottles 13, 14 are used for storing photoresist solutions 15, 16 required by different processes, respectively. The dispense pump 20, utilizing the principle of draining and pushing, drains the photoresist solutions 15, 16 in the photoresist bottles 13, 14, and then the photoresist solutions 15, 16 are pushed to a gyrate system 24 by a nozzle 22 to perform the photoresist coating process. Typically, the gyrate system 24 comprises a substrate 26, a chuck 28 replaceable depending on a diameter of the substrate 26, a chuck holder 29, and a spindle motor electrically connected to a velocity generator (both are not shown in FIG. 1) for providing the motive power for high speed spinning.

The working principle of the prior art photoresist coating system 10 is to position the substrate 26, to be coated with a photoresist layer, on the chuck 28 first. By utilizing the negative pressure generated by the dispense pump 20, the photoresist solution 15 in the photoresist bottle 13 or the photoresist solution 16 in the photoresist bottle 14 is drained, depending on the requirement of the process. The photoresist solution 15 or the photoresist solution 16 is delivered through pipes 18. After that, the pushing working principle, which is based on the positive pressure generated by the dispense pump 20, is utilized by the dispense pump 20. The drained photoresist solution 15 or the photoresist solution 16 is thus dropped to a surface of the substrate 26 through the nozzle 22. At the same time, the gyrate system 24 spins at a high speed so that a photoresist layer (not shown in FIG. 1) is evenly coated on the surface of the substrate 26.

It is worth noting that the photoresist solutions which are frequently used are mostly organic photoresist solutions. An organic photoresist solution is characterized by having an optimal viscosity to fulfill the requirements of a production line when the organic photoresist solution is preserved at approximately 5° C. As shown in FIG. 2, the photoresist solution that is not used yet cannot be kept in a low temperature state since there is not a design of temperature control in the prior art photoresist coating system 10. When the solvent in the photoresist solution is more volatile or the photoresist solution is not stable, the viscosity of the photoresist solution will be increased from 27 cps to 29.5 cps after the photoresist solution is stored at room temperature (approximately 25° C.) for a period of time (for example: 40 days). If the photoresist solution is stored in a frozen environment (approximately −15° C.) for about 40 days, the change of the viscosity of the photoresist solution is smaller. However, the viscosity of the photoresist solution is affected when the photoresist solution is stored in the frozen environment too long. Only when the photoresist solution is stored at an environment at approximately 5° C. can the photoresist solution be stored for more than 120 days without affecting the viscosity of the photoresist solution.

When the viscosity of the photoresist solution changes too much, the photoresist solution will undergo a chemical change, leading to obvious impact on the film thickness and the uniformity of the formed photoresist layer. If the photoresist layer having a poor film thickness uniformity is utilized to perform the photolithography process, the critical dimension (CD) of the semiconductor device or the opto-electronics device is seriously affected. The production yield is thus lowered. In addition, when the photoresist solution is positioned in the photoresist bottle for too long a period of time (that means the photoresist solution has been stored at room temperature longer than a predetermined period of time), or when the photoresist solution needs to be replaced by another photoresist solution due to process change, the photoresist solution undergoing a chemical change needs to be removed. Since the price of the photoresist solution is very expensive, the process cost is increased. Furthermore, time is wasted because the process cannot be switched right away.

### SUMMARY OF INVENTION

It is therefore a primary objective of the claimed invention to provide a photoresist coating system having a cooling system and a heating system to control a temperature of photoresist solution so that a photoresist spin coating process can be performed successfully.

According to the claimed invention, a photoresist coating system is provided. The photoresist coating system comprises a chemical tank, a cooling system, a heating system, and an automatic photoresist feed system. The chemical tank is used for positioning at least one photoresist bottle. The photoresist bottle is used for storing photoresist solution supplied to the photoresist coating system. The cooling system is used for chilling the photoresist solution in the photoresist bottle so as to keep the photoresist solution in the photoresist bottle at a low temperature. The heating system is used for heating the photoresist solution transferred from the photoresist bottle to an adequate temperature. The automatic photoresist feed system is used for draining and delivering the photoresist solution.

Since the present invention photoresist coating system comprises a cooling system and a heating system, the photoresist solutions not used yet can be kept at a low temperature to prolong the storage time of the photoresist solutions. Moreover, the temperature of the photoresist solutions transferred from the photoresist bottles can be increased to room temperature to allow the photoresist solutions to be switched at any time. As a result, the present invention photoresist coating system not only shortens the time required for switching photoresist solutions when the process is changed, but also obviously decreases the amount of the photoresist solutions used. The processing cost is thus reduced.

These and other objectives of the claimed invention will become obvious to those of ordinary skill in the art after having read the following detailed description of the preferred embodiment that is illustrated in the various figures and drawings.

### BRIEF DESCRIPTION OF DRAWINGS

FIG. 1 is a structural schematic diagram of a prior art photoresist coating system.

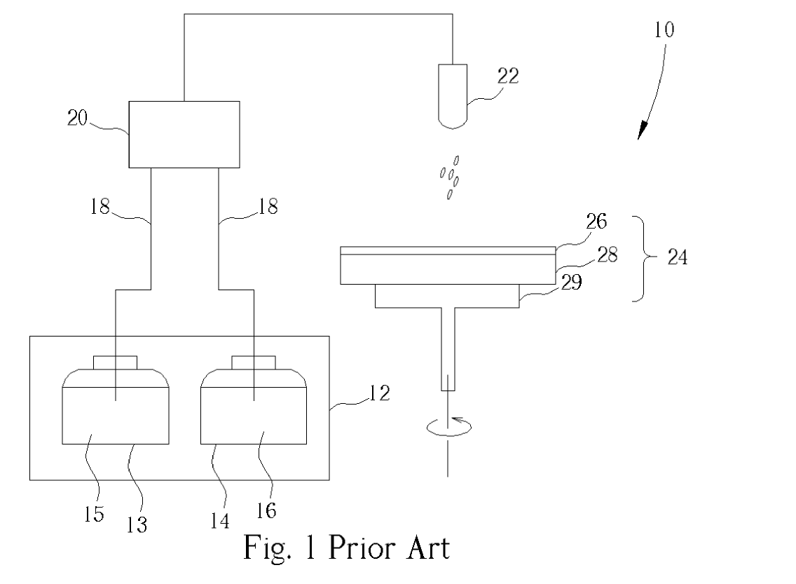

FIG. 2 is a viscosity of photoresist solution-storage time curve at different temperatures.

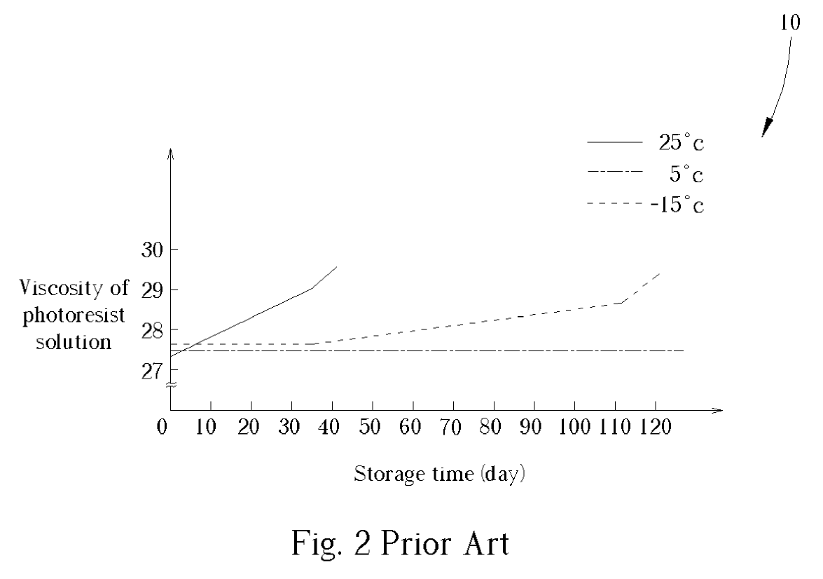

FIG. 3 is a structural schematic diagram of a present invention photoresist coating system.

### DETAILED DESCRIPTION

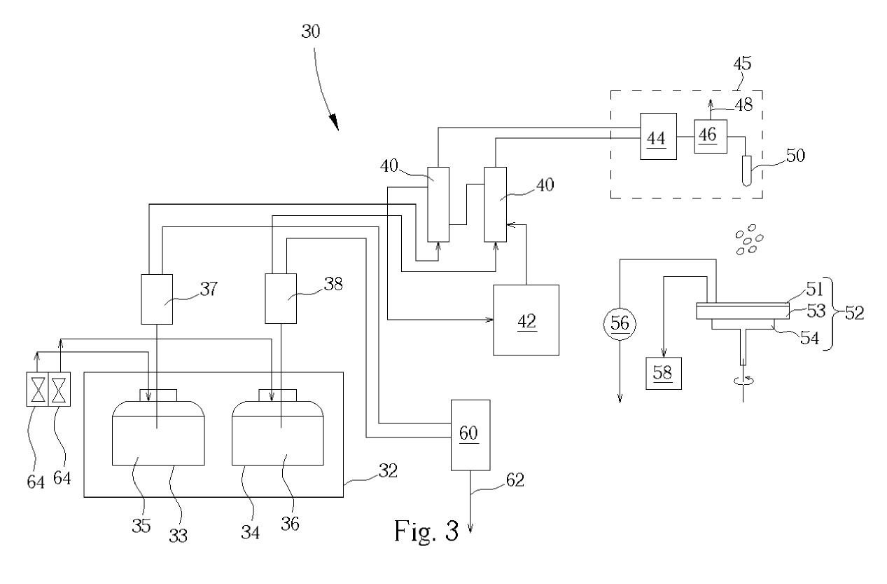

Please refer to FIG. 3. FIG. 3 is a structural schematic diagram of a present invention photoresist coating system 30. As shown in FIG. 3, the present invention photoresist coating system 30 mainly comprises a chemical tank 32 for positioning a plurality of photoresist bottles, depending on the requirements of processes. In a preferred embodiment of the present invention, two photoresist bottles 33, 34 are taken as an example for illustration. The photoresist bottles 33, 34 are respectively used for storing photoresist solutions 35, 36 supplied to the photoresist coating system 30. The photoresist coating system 30 further comprises a cooling system 40 for chilling the photoresist solutions 35, 36 in the photoresist bottles 33, 34, a heating system 42 for heating the photoresist solutions 35, 36 transferred from the photoresist bottles 33, 34, an automatic photoresist feed system 45 for draining and delivering the photoresist solutions 35, 36, and a gyrate system 52 for positioning a substrate 51 and controlling the rotation of the substrate 51.

The present invention automatic photoresist feed system 45 further comprises a draining and pushing device 44 that utilizes the principle of draining and pushing to drain and push the photoresist solutions 35, 36 in the photoresist bottles 33, 34. For example: nitrogen or dry air is supplied to pressurize to drain and push the photoresist solutions 35, 36 in the photoresist bottles 33, 34. The automatic photoresist feed system 45 also comprises a photoresist filter 46 having a exhaust 48 for emitting the impurities in the photoresist solution 35 and the photoresist solution 36, and a nozzle 50 for dropping the photoresist solutions 35, 36 to the gyrate system 52. In addition, the present invention gyrate system 52 further comprises a substrate 51, a chuck 53 replaceable depending on a diameter of the substrate 51, a chuck holder 54, a spindle motor electrically connected to a velocity generator (both are not shown in FIG. 3) for providing the electrical power for spinning, and a gas transferring and exhausting system 56 for conducting air to the photoresist coating system 30 and distributing air to a surface of the substrate 51. In addition, the gas transferring and exhausting system 56 also exhausts the air flowing through the surface of the substrate 51. Under the circumstances, the process is benefited to obtain the photoresist layer having a good film thickness uniformity.

It is worth noting that the present invention cooling system 40 can chill the photoresist solutions 35, 36 in the photoresist bottles 33, 34 with any method. For example, the cooling system 40 may be a water cooled cooling system and mainly comprises a coolant, a water jacket, a water pump, a water tank, or a thermostat (all are not shown in FIG. 3). By circulating the coolant, the extra heat is transferred to the outside of the chemical tank 32 so that the photoresist solutions 35, 36 not used are kept at a low temperature, such as between −5° C. and −20° C. Similarly, the present invention heating system 42 may be any type of heater. For example, the heating system 42 may be a heat exchanger to heat the photoresist solutions 35, 36 originally at a low temperature to room temperature, such as between 20° C. and 25° C., to allow the process to be performed successfully. However, the number of the heat exchangers is dependent on temperature rise rate. Furthermore, the present invention photoresist coating system 30 further comprises at least one temperature sensor (not shown in FIG. 3) for detecting a temperature of the photoresist solutions 35, 36, and a control circuit (not shown in FIG. 3) electrically connected to the temperature sensor, the cooling system 40, and the heating system 42 for temperature controlling.

Please refer to FIG. 3 again. The present invention photoresist coating system 30 further comprises two sensors 37, 38 and a bubble trap tank 60. The sensors 37, 38 are used for detecting an amount of the photoresist solutions 35, 36 in the photoresist bottles 33, 34, respectively. In other words, the sensors 37, 38 are used for detecting whether the photoresist solutions 35, 36 are used up or not. The bubble trap tank 60 has an exhaust 62 for releasing air such that air in the empty photoresist bottles does not remain in the pipes of the photoresist coating system 30 when the photoresist solutions are used up and the photoresist bottles need to be replaced. In addition, the bubble trap tank 60 is also used for collecting bubbles in the photoresist solutions

The working principle of the present invention photoresist coating system 30 is to utilize the draining and pushing device 44 to drain the photoresist solution 35 in the photoresist bottle 33 or the photoresist solution 36 in the photoresist bottle 34 first. Since there is the cooling system 40 in the present invention photoresist coating system 30, the photoresist solutions 35, 36 not used can be stored at a low temperature to allow the photoresist solutions 35, 36 to be properly stored. When the photoresist solution 35 in the photoresist bottle 33 or the photoresist solution 36 in the photoresist bottle 34 is drained up, in other words before replacing the photoresist bottles 33 or the photoresist bottle 34, the sensors 37 or the sensor 38 will sense the air drained from the photoresist bottles 33 or the photoresist bottle 34 and transfer a disable signal to the photoresist coating system 30. At this time, a valve taking charge of the exhaust 62 of the bubble trap tank 60 is opened to release the air drained to the sensors 37 or the sensor 38. The photoresist bottle 33 or the photoresist bottle 34 may be replaced after the disable signal is transferred to the photoresist coating system 30, or after the air drained to the sensor 37 or the sensor 38 is released. Then, the draining and pushing device 44 drains the photoresist solution 35 in the photoresist bottle 33 or the photoresist solution 36 in the photoresist bottle 34 to the heating system 42 to allow the photoresist solution 35 in the photoresist bottle 33 or the photoresist solution 36 in the photoresist bottle 34 to be heated to room temperature. After that, the draining and pushing device 44 utilizes the working principle of pushing to filter the drained photoresist solution 35 or the photoresist solution 36 through the photoresist filter 46. The impurities in the photoresist solution 35 or the photoresist solution 36 are thus emitted out from the exhaust 48. The photoresist solution 35 or the photoresist solution 36 is dropped to the surface of the substrate 51 through the nozzle 50. At the same time, the gyrate system 52 spins at a high speed so that a photoresist layer (not shown in FIG. 3) is evenly coated on the surface of the substrate 51.

It is worth noting that the present invention photoresist coating system 30 may further comprise a waste collecting system and a deflector (not shown in FIG. 3) for reclaiming the extra sprayed photoresist solution when the gyrate system 52 is rotating during the spinning coating process, and for preventing the photoresist solution from sputtering back to the surface of the substrate 51. In addition, a slight amount of nitrogen is pumped to the inside of the chemical tank 32 from a nitrogen storage tank 64 to prevent dew from forming on the surface of the chemical tank 32.

Compared with the prior art photoresist coating system, the present invention photoresist coating system comprises a cooling system and a heating system. Therefore, the photoresist solutions not used can be stored at a low temperature to ensure that the quality of the photoresist solutions are very stable and the solvents in the photoresist solutions are less volatile. Not only is the storage time prolonged, but also the temperature of the photoresist solutions transferred from the photoresist bottles can be increased to room temperature at any time to supply the spinning coating process. As a result, the present invention photoresist coating system can avoid the problem of photoresist solution waste when one process is switched to another process. The processing cost is thus reduced. Furthermore, different photoresist solutions are switched at any time to shorten the time required for switching photoresist solutions, leading to convenience when performing the related processes.

Those skilled in the art will readily observe that numerous modifications and alterations of the device may be made while retaining the teaching of the invention. Accordingly, the above disclosure should be construed as limited only by the metes and bounds of the appended claims.

1. A photoresist coating system comprising:
a chemical tank for positioning at least one photoresist bottle, the photoresist bottle being used for storing photoresist solution supplied to the photoresist coating system;
a cooling system for chilling the photoresist solution in the photoresist bottle;
a heating system for heating the photoresist solution; and
an automatic photoresist feed system for draining and delivering the photoresist solution.

2. The photoresist coating system of claim 1 further comprising at least one sensor for detecting an amount of the photoresist solution in the photoresist bottle.

3. The photoresist coating system of claim 1 further comprising at least one temperature sensor for detecting a temperature of the photoresist solution in the photoresist bottle, and a control circuit electrically connected to the temperature sensor, the cooling system, and the heating system for temperature controlling.

4. The photoresist coating system of claim 1 wherein a temperature of the cooling system is between −5° C. and 20° C.

5. The photoresist coating system of claim 1 wherein a temperature of the heating system is between 20° C. and 25° C.

6. The photoresist coating system of claim 1 wherein the cooling system comprises a coolant, a water jacket, a water pump, a water tank, or a thermostat.

7. The photoresist coating system of claim 1 wherein the heating system comprises at least one heat exchanger.

8. The photoresist coating system of claim 1 wherein the automatic photoresist feed system comprises a draining and pushing device for draining the photoresist solution in the photoresist bottle and pushing the photoresist solution to a surface of a substrate through a nozzle by utilizing the principle of draining and pushing.

9. The photoresist coating system of claim 1 further comprising a bubble trap tank for collecting bubbles in the photoresist solution.

10. The photoresist coating system of claim 1 further comprising a waste collecting system for reclaiming the photoresist solution sprayed during spinning coating.

11. A method for performing a photolithography process by a photoresist coating system comprising the following steps:
providing a plurality of photoresist solutions, each of the photoresist solutions being stored in a photoresist bottle;
chilling the photoresist solutions to a first temperature by a cooling system in the photoresist coating system;
selecting a first photoresist solution among the plurality of photoresist solutions;
heating portions of the first photoresist solution to a second temperature by a heating system in the photoresist coating system; and
delivering the heated first photoresist solution by an automatic photoresist feed system.

12. The method of claim 11 wherein the step of delivering the heated first photoresist solution by an automatic photoresist feed system further comprises the following steps:
utilizing a draining and pushing device to filter the heated first photoresist solution through a photoresist filter; and
dropping the heated first photoresist solution to a surface of a substrate through a nozzle.

13. The method of claim 12 wherein the photoresist bottles for storing the plurality of photoresist bottles are positioned in a chemical tank.

14. The method of claim 13 further comprising a step of pumping nitrogen to the inside of the chemical tank.

15. The method of claim 11 wherein the first temperature is between −5° C. and −20° C.

16. The method of claim 11 further comprising the following steps before selecting the first photoresist solution among the plurality of photoresist solutions:
sensing air drained from the photoresist bottle for storing the first photoresist solution and transferring a disable signal to the photoresist coating system;
releasing the air drained from the photoresist bottle for storing the first photoresist solution; and
draining the first photoresist solution to the heating system.

17. The method of claim 16 wherein the photoresist bottle for storing the first photoresist solution is replaced before releasing the air drained from the photoresist bottle for storing the first photoresist solution.

18. The method of claim 16 wherein at least one sensor is utilized to sense the air drained from the photoresist bottle for storing the first photoresist solution, and a bubble trap tank having an exhaust taken charge by a valve is utilized to release the air.

19. The method of claim 16 wherein the photoresist bottle for storing the first photoresist solution is replaced before draining the first photoresist solution to the heating system.

20. The method of claim 11 wherein the second temperature is between 20° C. and 25° C.
